(19) United States
(12) Patent Application Publication
(10) Pub. No.: US 2009/0160633 A1
(43) Pub. Date: Jun. 25, 2009

(54) BRAKE LIGHT SYSTEM FOR UTILITY VEHICLE

(75) Inventors: Warren Clark, Evans, GA (US); Aric Singletary, Hephzibah, GA (US); Oliver A. Bell, JR., Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/962,743

(22) Filed: Dec. 21, 2007

(51) Int. Cl. B60Q 1/44

(52) U.S. Cl. 340/479

(57) ABSTRACT

A brake lighting system for a lightweight utility vehicle is provided. The brake lighting system can comprise a pressure sensitive brake light switch (PSBLS) operably connected to a brake pedal subassembly of the vehicle. The PSBLS is configured such that depression of a brake pedal included in the brake pedal subassembly compresses the pressure sensitive brake light switch. The brake lighting system additionally can comprise a brake light circuit that can comprise at least one brake light and an electronic switching device communicatively connected to the PSBLS. The electronic switching device is responsive to a brake light signal transmitted by the PSBLS when the PSBLS is compressed. Upon receipt of the brake light signal, the electronic switching device enables a current flow through the brake light to illuminate the brake light.

### FIELD

The present disclosure relates to a brake light system for a vehicle.

### BACKGROUND

Known vehicles, e.g., automobiles and light-weight utility vehicles, typically include an acceleration control assembly and a braking control assembly for controlling movement of the vehicle. Generally, the acceleration control assembly controls a primary mover, e.g., a motor or engine, that imparts motive forces on at least one drive wheel of the vehicle to affect movement of the vehicle. The braking control assembly typically controls operation of mechanical drum, shoe, and pad brake mechanisms, mechanical steel band and polished drum brake mechanisms, mechanical rotor and caliper brake mechanism, or in some instances, regenerative braking available when the primary mover is an electric motor.

Typically, the braking assembly includes a brake pedal connected to a brake arm that pivots at a distal when a vehicle operator depresses the brake pedal. The pivoting motion or movement of the brake arm typically activates a brake light switch to illuminate one or more brake lights. Activation of the brake light switch is dependent on physical interaction between the brake arm and the switch as the brake arm moves or pivots. Such brake light switches add considerably to parts, labor and tooling costs, complexity, and weight to the brake assemblies.

### SUMMARY

In various embodiments, a brake lighting system for a lightweight utility vehicle is provided. The brake lighting system can comprise a pressure sensitive brake light switch (PSBLS) operably connected to a brake pedal subassembly of the vehicle. The PSBLS is configured such that pressure or force applied to a brake pedal included in the brake pedal subassembly compresses the pressure sensitive brake light switch. The brake lighting system additionally can comprise a brake light circuit that can include at least one brake light and an electronic switching device communicatively connected to the PSBLS. The electronic switching device is responsive to a brake light signal transmitted by the PSBLS when the PSBLS is compressed. Upon receipt of the brake light signal, the electronic switching device enables a current flow through the brake light to illuminate the brake light.

### BRIEF DESCRIPTION OF THE DRAWINGS

The present disclosure will become more fully understood from the detailed description and the accompanying drawings, wherein:

FIG. 1 is a side view of a vehicle including a brake lighting system for controlling illumination of at least one vehicle brake light, in accordance with various embodiments of the present disclosure;

FIG. 2 is a block diagram of the brake lighting system shown in FIG. 1, in accordance with various embodiments of the present disclosure;

FIG. 3 is an isometric view of an accelerator pedal subassembly and a brake pedal subassembly of the vehicle shown in FIG. 1, including a pressure sensitive brake light switch of the brake lighting system, shown in FIG. 2, in accordance with various embodiments; and

FIG. 4 is an exploded view of the brake pedal subassembly shown in FIG. 3 including the pressure sensitive brake light switch of the brake lighting system, shown in FIG. 2, in accordance with various embodiments.

### DETAILED DESCRIPTION

The following description of the various embodiments is merely exemplary in nature and is in no way intended to limit the disclosure, its application, or uses.

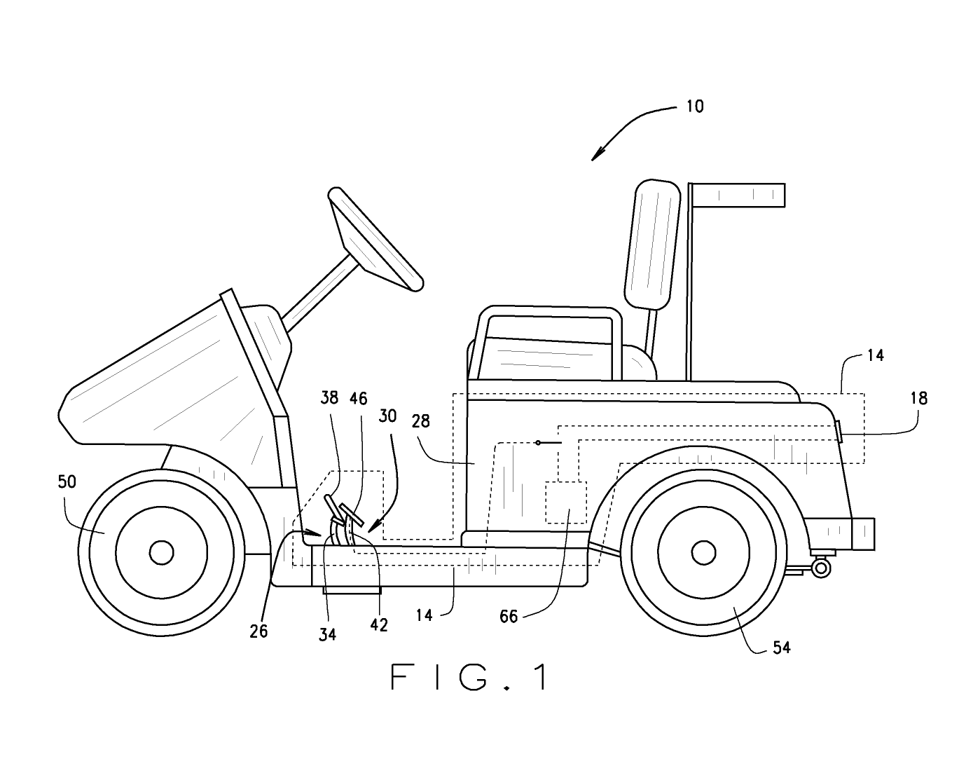

FIG. 1 depicts a light-weight utility vehicle 10, such as a small cargo/maintenance vehicle, a shuttle vehicle or a golf car, including a brake lighting system 14, in accordance with the various embodiments of the present disclosure. Generally, the brake lighting system 14 controls illumination of at least one brake light 18. The vehicle 10 additionally includes a primary mover 22, e.g., a motor or engine, that delivers torque to affect movement of the vehicle 10, an accelerator pedal subassembly 26 for controlling acceleration of the vehicle 10 and a brake pedal subassembly 30 for controlling braking of the vehicle 10. The accelerator pedal subassembly 26 includes an accelerator pedal arm 34 fixedly coupled to an accelerator pedal 38 via any suitable coupling means, including, by way of non-limiting example, rivets, screws, nuts and bolts or welding. Alternatively, the accelerator pedal arm 34 and pedal 38 can be a one piece plastic or cast metal component. Similarly, the brake pedal subassembly 30 includes a brake pedal arm 42 fixedly coupled to a brake pedal 46 via any suitable coupling means, for non-limiting example, rivets, screws, nuts and bolts, or welding. Alternatively, the brake pedal arm 42 and pedal 46 could be a one piece plastic or cast metal component. The vehicle 10 further includes a pair of front wheels 50 that generally operate to steer the vehicle 10, and a pair of rear wheels 54, at least one of which functions as a drive wheel for propelling the vehicle 10.

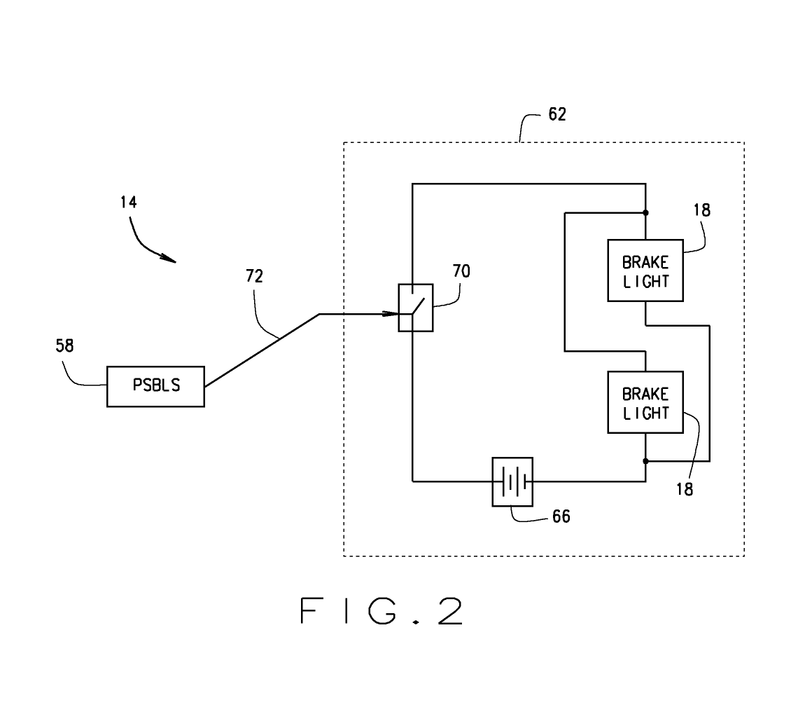

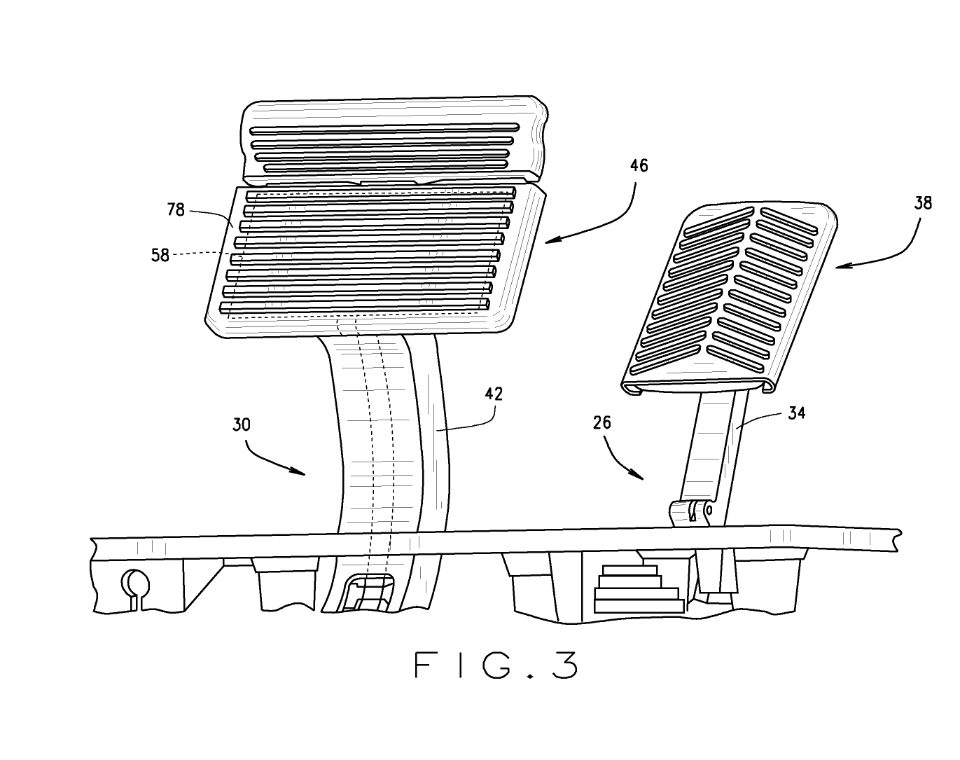

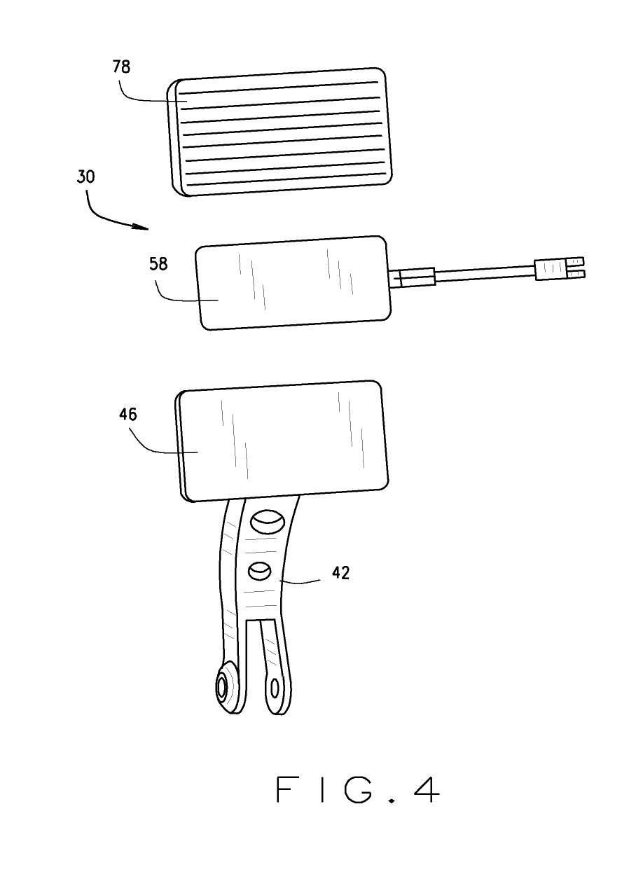

FIG. 2 illustrates a block diagram of the brake lighting system shown in FIG. 1. In various implementations, the brake lighting system 14 includes a pressure sensitive brake light switch 58 communicatively connected to a brake light circuit 62. The brake light circuit 62 can comprise a power source 66, e.g., a 12V battery, that provides power, i.e., voltage across and current though the brake light(s) 18. The brake light circuit 62 also comprises an electronic switching device 70 that is communicatively connected to the pressure sensitive brake light switch 58 and controls the flow of current through the brake light circuit 62. Generally, the pressure sensitive brake light switch 58 is operably connected to the brake pedal subassembly 30 such that pressure applied to the brake pedal 46, e.g., pressure applied to depress the brake pedal 46, closes the pressure sensitive brake light switch 58. Upon closure, the pressure sensitive brake light switch 58 outputs a brake light signal 72, e.g., a voltage output, to the electronic switching device 70 that drives, activates or closes the electronic switching device 70 to allow a current flow through brake light circuit 62. Accordingly, the current flows through the brake light(s) 18 illuminating the brake light(s) 18. It should be understood that the brake lighting system 14, as described herein, is applicable to various types or configurations of brake pedal subassemblies 30. For example, in various embodiments, the brake lighting system 14 can be employed with a stand alone brake pedal subassembly 30, such as that shown in FIG. 4. Alternatively, in accordance with various other implementations, the brake lighting system 14 is can be employed with a brake pedal subassembly 30 that is part of a modular accelerator and brake assembly, as illustrated in FIG. 3. Such a modular accelerator and brake assembly is described in co-pending patent application titled, Modular Pedal Box Assembly, application Ser. No. 11/163,844, filed Nov. 1, 2005, and assigned to the assignee of the present application.

Referring to FIGS. 3 and 4, in various embodiments, the brake pedal subassembly 30 can include a brake pedal pad 78 connected to or fitted over the brake pedal 46. The brake pedal pad 78 can be fabricated from any somewhat pliable material suitable to provide a textured surface for the respective brake pedal 46 that will assist the driver in maintaining safe control and operation of the brake pedal 46, For example, in various embodiments, the brake pedal pad 78 can be fabricated from rubber or similar material.

In various embodiments, the pressure sensitive brake light switch 58 is included in the brake pedal subassembly 30. More particularly, as exemplarily illustrated in FIGS. 3 and 4, in various implementations, the pressure sensitive brake light switch 58 can be placed between the brake pedal 46 and the brake pedal pad 78. Locating the pressure sensitive brake light switch 58 between brake pedal and pad 46 and 78 conceals the pressure sensitive brake light switch 58 from view. Additionally, locating the pressure sensitive brake light switch 58 between brake pedal and pad 46 and 78 protects the pressure sensitive brake light switch 58 from exposure to water, debris and other contaminates that could harm the pressure sensitive brake light switch 58.

The pressure sensitive brake light switch 58 can be any suitable pressure sensitive switch that operates to output the brake light signal 72 to the electronic switching device 70 when pressure is applied to the brake pedal pad 78, i.e., when the brake pedal 46 is depressed. For example, the pressure sensitive brake light switch 58 can be a non-contact pressure sensitive switch, a membrane switch or a tape switch.

In various embodiments, the pressure sensitive brake light switch 58 can be molded into, or integrally formed with, the brake pedal pad 78. In various other embodiments, the pressure sensitive brake light switch 58 can be affixed to the brake pedal pad 78, or affixed to the brake pedal 46. For example, the pressure sensitive brake light switch 58 can be glued, screwed, stapled or riveted to the brake pedal 46 or the brake pedal pad 78. Alternatively, in various implementations, the pressure sensitive brake light switch 58 can be a wire molded into the brake pedal pad 78 such that when the brake pedal pad 78 is compressed, as the brake pedal 46 is depressed, an exposed portion of the wire contacts the metallic brake pedal 46. Contact of the wire with the metallic brake pedal 46 completes an electrical circuit to transmit the brake light signal 72 to drive the electronic switching device 70 to close the brake light circuit 62 and illuminate the brake light(s) 18.

When the brake pedal and pad 46 and 78 are depressed to initiate a braking operation of the vehicle 10, the pressure sensitive brake light switch 58 is compressed, i.e., activated or closed, and transmits the brake light signal 72, e.g., a voltage output, to the electronic switching device 70. When the electronic switching device 70 receives the brake light signal 72 from the pressure sensitive brake light switch 58, the electronic switching device 70 closes to complete, or close, the brake light circuit 62. Closing the brake light circuit 62 electrically connects the power source 66 to the brake light(s) 18 such that current flows through the brake light circuit 62 illuminating brake light(s) 18 to indicate the braking operation of the vehicle 10.

Conversely, when the brake pedal and pad 46 and 78 are released, or not depressed, the pressure sensitive brake light switch 58 is not compressed and terminates, or does not transmit, the brake light signal 72. In response to the termination or absence of the brake light signal 72, the electronic switching device 70 opens, breaking the brake light circuit 62, and terminating or preventing current flow through the brake light circuit 62 such that the brake light(s) 18 are extinguished or not illuminated. Thus, the brake light(s) 18 are only illuminated when pressure is applied to the brake pedal 46 and pad 78, for example, when pressure is applied by a vehicle operator stepping on the brake pedal and pad 46, and 78. The applied pressure compresses the pressure sensitive brake light switch 58, which then transmits the brake light signal 72 to the electronic switching device 70. In response to the brake light signal 72, the electronic switching device 70 closes, allowing current to flow through the brake light circuit 62 to illuminate the brake light(s) 18.

The electronic switching device 70 can be any electronic switching device suitable for receiving the brake light signal 72 and controlling the flow of current through the brake light circuit 62. For example, the electronic switching device 70 can be an electro-mechanical relay switch, a transistor, a field effect transistor (FET) or a insulated gate bipolar transistor (IGBT). In various implementations, the electronic switching device 70 is normally open such that current does not flow through the brake light circuit 62 and the brake light(s) 18 is/are normally extinguished, i.e., not illuminated.

The description herein is merely exemplary in nature and, thus, variations that do not depart from the gist of that which is described are intended to be within the scope of the teachings. Such variations are not to be regarded as a departure from the spirit and scope of the teachings. Additionally, in the event that one or more of the incorporated literature and similar materials differs from or contradicts this application, including but not limited to defined terms, term usage, described techniques, or the like, this application controls.

What is claimed is:

1. A brake lighting system for a lightweight utility vehicle, said system comprising:
a pressure sensitive brake light switch (PSBLS) operably connected to a brake pedal subassembly;
an electronic switching device communicatively connected to the PSBLS and responsive to a brake light signal transmitted by the PSBLS when the PSBLS is compressed; and
at least one brake light configured to receive a current flow resulting from the electronic switching device closing a brake light circuit upon receipt of the brake light signal.

2. The system of claim 1, wherein the brake pedal subassembly comprises a brake pedal and a brake pedal pad fitted over the brake pedal and the PSBLS is placed between the brake pedal and the brake pedal pad.

3. The system of claim 1, wherein the brake pedal subassembly comprises a brake pedal and a brake pedal pad fitted over the brake pedal, the brake pedal pad comprising the PSBLS integrally formed therein.

4. The system of claim 1, wherein the brake pedal subassembly comprises a brake pedal and a brake pedal pad fitted over the brake pedal, the PSBLS being affixed to the brake pedal pad.

5. The system of claim 1, wherein the brake pedal subassembly comprises a brake pedal and a brake pedal pad fitted over the brake pedal, the PSBLS being affixed to the brake pedal.

6. The system of claim 1, wherein the brake pedal subassembly comprises a metallic brake pedal and a brake pedal pad fitted over the metallic brake pedal, and the PSBLS comprises a wire integrally formed with brake pedal pad such that when the brake pedal pad is compressed an exposed portion of the wire contacts the metallic brake pedal thereby transmitting the brake light signal.

7. The system of claim 1, wherein the PSBLS comprises one of a non-contact pressure sensitive switch, a membrane switch or a tape switch.

8. The system of claim 1, wherein the system further comprises a brake light circuit, the brake light circuit comprising the electronic switching device, a power source and the brake light, wherein the electronic switching device completes the brake light circuit upon receipt of the brake light signal connecting the power source across the brake light and causing the current flow through the brake light circuit illuminating the brake light.

9. The system of claim 1, wherein the electronic switching device opens the brake light circuit when not receiving the brake light signal so that current does not flow through the brake light circuit and a brake light is not illuminated.

10. A method for controlling illumination of a lightweight utility vehicle brake light, said method comprising:
transmitting a brake light signal from a pressure sensitive brake light switch (PSBLS) operably connected to a brake pedal subassembly when the PSBLS is compressed; and
closing an electronic switching device in response to brake light signal to close a brake light circuit and provide current to at least one brake light for illuminating the brake light.

11. The method of claim 10, wherein transmitting the brake light signal comprises positioning the PSBLS between a brake pedal of the brake pedal subassembly and a brake pedal pad fitted over the brake pedal such that the PSBLS is compressed when the brake pedal is depressed.

12. The method of claim 10, wherein the method further comprises terminating transmission of the brake light signal when the PSBLS is in a non-compressed state.

13. The method of claim 12, wherein the method further comprises opening the electronic switching device when transmission of the brake light signal is terminated to open the brake light circuit such that current flow through the brake light circuit is terminated and the brake light is extinguished.

14. A lightweight utility vehicle comprising:
a brake lighting system, said brake lighting system comprising:
a pressure sensitive brake light switch (PSBLS) operably connected to a brake pedal subassembly such that pressure applied to a brake pedal of a brake pedal subassembly compresses the pressure sensitive brake light switch; and
a brake light circuit comprising:
at least one brake light; and
an electronic switching device communicatively connected to the PSBLS and responsive to a brake light signal transmitted by the PSBLS when the PSBLS is compressed to enable a current flow through the brake light.

15. The vehicle of claim 14, wherein the brake pedal subassembly comprises the brake pedal and a brake pedal pad fitted over the brake pedal and the PSBLS is located between the brake pedal and the brake pedal pad.

16. The vehicle of claim 14, wherein the brake pedal subassembly comprises the brake pedal and a brake pedal pad fitted over the brake pedal, the brake pedal pad comprising the PSBLS integrally formed therein.

17. The vehicle of claim 14, wherein the brake pedal subassembly comprises the brake pedal and a brake pedal pad fitted over the brake pedal, the PSBLS being affixed to one of the brake pedal pad and the brake pedal.

18. The vehicle of claim 14, wherein the brake pedal subassembly comprises a metallic brake pedal and a brake pedal pad fitted over the brake pedal, and the PSBLS comprises a wire integrally formed with brake pedal pad such that when the brake pedal pad is compressed an exposed portion of the wire contacts the metallic brake pedal thereby transmitting the brake light signal.

19. The vehicle of claim 14, wherein the brake light circuit further comprises a power source, wherein the electronic switching device completes the brake light circuit upon receipt of the brake light signal connecting the power source across the brake light and causing the current flow through the brake light circuit illuminating the brake light.

20. The vehicle of claim 19, wherein the electronic switching device opens the brake light circuit when not receiving the brake light signal so that current does not flow through the brake light circuit and a brake light is not illuminated.
